(19) United States
(12) Patent Application Publication
(10) Pub. No.: US 2002/0186404 A1
(43) Pub. Date: Dec. 12, 2002

(54) Printer including video encoder

(76) Inventor: Brian D. Gragg, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/877,613

(22) Filed: Jun. 9, 2001

(51) Int. Cl. B41B 1/00; G06F 15/00

(52) U.S. Cl. 358/1.15

(57) ABSTRACT

A printer capable of video-encoding digital images. The encoded images can be sent to, and displayed by, a television. Proofing and selection can be based on large, high resolution images on the television instead small, low quality thumbnail images on a proof sheet. Moreover, the digital images can be proofed, selected and printed out without the assistance of a personal computer.

### BACKGROUND

Personal computers often play an integral role in processing digital images. As an example, a scanner captures digital images and sends the digital images to a personal computer. Photo editing software on the personal computer is used to touch up and proof the digital images and select the images to be printed out. The selected images are sent to a printer driver, which also runs on the computer. The printer driver converts the selected images to a format for printing, and sends the formatted images to a printer.

As another example, a digital camera is equipped with memory for storing captured digital images. After the memory has been filled, the digital images are transferred to a personal computer. Photo editing software is used to touch up, proof and select the digital images, and a printer driver formats the selected images and sends the formatted images to a printer.

However, the personal computer does not always play an integral role in printing out digital images. For instance, the HP Photosmart P1100 printer includes a memory reader that can accommodate removable memory. In a digital camera having removable memory, the memory can be removed from the camera and plugged into the memory reader. The HP Photosmart P1100 printer can then select and print out digital images stored in the removable memory. Thus the Photosmart P1100 can print out photos directly from the memory, without the assistance of a personal computer.

Eliminating the personal computer-as-middleman makes it easier to print out digital images. It also reduces cost and increases portability.

Proofing and selecting the digital images, however, has its drawbacks. Typically, a proof sheet of thumbnail images is printed out, and the selection is based on the thumbnail images. The thumbnail images are small and their resolution is low. As a result, the quality of the images is difficult to evaluate. For the most part, the thumbnail images merely allow the contents of the memory to be identified.

In addition, printing out a proof sheet can take several minutes. Therefore, the proofing can take a relatively long time. Moreover, paper and ink are spent to produce the proof sheet.

### SUMMARY

According to one aspect of the present invention, a printer is capable of video-encoding digital images. The encoded images can be sent to, and displayed by, a television. Proofing and selection can be based on large, high resolution images on the television instead small, low quality thumbnail images on a proof sheet. Moreover, the digital images can be proofed, selected and printed out without the assistance of a personal computer.

Other advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a printer according to the present invention.

FIG. 2 is an illustration of a home audio video network.

FIG. 3 is an illustration of a method of proofing digital images.

### DETAILED DESCRIPTION

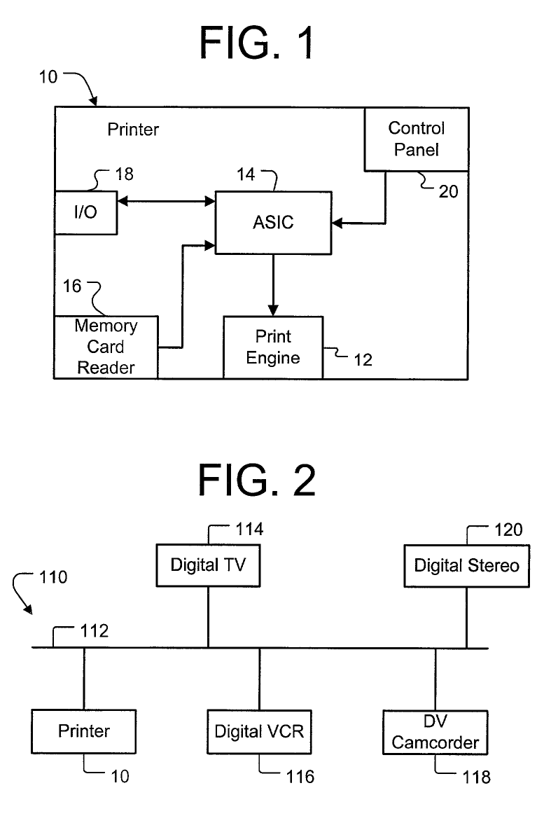

FIG. 1 shows a printer 10 including a print engine 12 and an application specific integrated circuit (ASIC) 14. The ASIC 14 can perform conventional control of the print engine 12.

The printer 10 further includes a memory card reader 16 that can read removable memory. Popular types of removable memory include, but are not limited to, “Memory Sticks,” Smart Cards” and “Compact Flashcards.”

Such removable memory is commonly used in digital cameras, personal digital assistants (PDAs) and other mobile devices. The memory card reader 16 can read digital images stored in the removable memory.

The printer 10 can also receive digital images via an input/output (I/O) interface 18. The digital images may be received, for example, via a USB or IEEE 1394 interface.

The ASIC 14 also performs video-encoding of the digital images. The type of video-encoding depends upon the type of device on which the images are displayed. For example, the ASIC 14 could encode the digital images according to a format such as a digital video (DV) format. Such encoded images can be displayed on a digital television. The ASIC 14 could also apply color correction, sharpening, etc., to the digital images. The ASIC 14 supplies a video stream to the I/O interface 18. A still image can be displayed by repeating the same image in the video stream.

Displaying the images on the video display device allows the images to proofed and evaluated. The video display device displays the digital images at a much higher resolution and a much larger size than thumbnail images on a proof sheet. Not only can the memory content be identified, but image quality can be evaluated, and fine details can be discerned. Consequently, decisions to print can be based on image quality. Selected images can then be printed by the print enginel 2.

Using the video display device to proof and select images has other advantages over a conventional method such as printing out proof sheets of low-quality thumbnail images and selecting from the thumbnails on the proof sheets. Paper and ink are saved. The proofing is also much faster than printing out proof sheets, since the images appear on the video display device immediately.

There are various ways of sequencing through the digital images (i.e., accessing, encoding and displaying the digital images) and selecting the digital images to print. For instance, the printer 10 could be provided with a control panel 20 and the ASIC 14 could control the sequencing and selection in response to buttons on the control panel 20. The buttons would allow for manual sequencing and selection of the digital images. The digital images could be displayed one at a time. A “forward” button on the control panel 20 might cause the next digital image to be displayed, a “back” button might cause the previous image to be displayed, and a “print” button might cause the displayed (current) image to be selected and printed.

In the alternative or in addition, the printer 10 may be provided with a receiver that receives a signal from a remote control. Sequencing and selection could be controlled by the remote control.

The digital images could be displayed in groups of thumbnails, with each displayed thumbnail being identified by a number. The control 20 could have a keypad for keying in the number or numbers of the images to be printed.

The control panel 20 could include a button for automatically sequencing through the digital images. For example, the digital images could be displayed on the video display device as a slide show. When a desirable image is displayed, the print button is pressed.

Referring to FIG. 2, the printer 10 can be connected to a home audio video network 110 situated in a home entertainment center. The I/O interface 18 of the printer 10 is connected to a backbone 112 of the network 110. Other devices connected to the backbone 112 might include a digital television 114, a digital VCR 116, a digital camcorder 118, and a digital stereo 120. A computer need not be attached. Once connected to the network 110, the printer 10 can send video-encoded images to the digital television 114 for display.

The network 110 could follow the HAVi specification, a consumer electronics industry architecture. Digital audio and video devices conforming to the HAVi standard are interoperable when connected to the network 110. Such a network 110 would allow any of these devices to generate remote signals for commanding the printer 10 to sequence through, select and print the images.

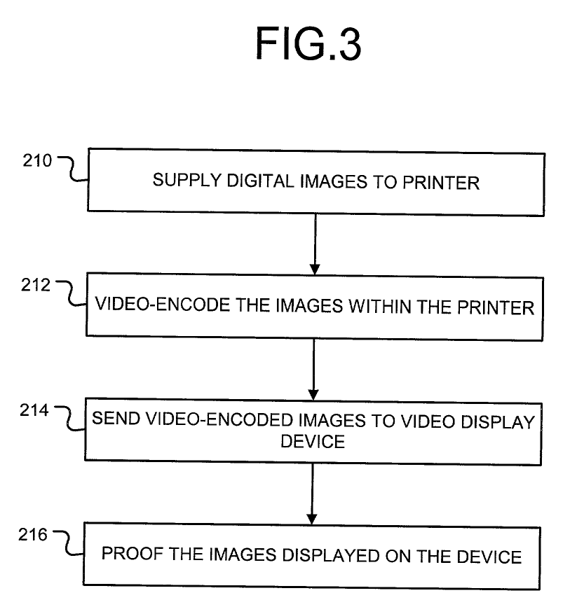

Thus, the digital images can be proofed as shown in FIG. 3. Digital images are supplied to the printer 10 (210), the digital images are video-encoded within the printer 10 (212); the encoded images are sent to the digital television 114 or other remote video display device (214); and the images displayed on the remote video display device are proofed and selected for printing (216).

The printer 10 is not limited to all of the elements described above. For example, the memory card reader 16 could be eliminated, whereby the printer receives digital images only from the I/O interface 18.

The video-encoding, print engine control and image sequencing control may be performed by a single ASIC. Within the ASIC, these functions may be performed by dedicated circuits, by a single embedded processor that is programmed to performed these functions, or by a combination thereof. These functions may instead be performed by separate ASICS.

The printer 10 is not limited to video-encoding in a format for a digital display device. The printer 10 could perform video-encoding in a format for an analog display device such as an analog television.

The present invention is not limited to the specific embodiments described and illustrated above. Instead, the present invention is construed according to the claims that follow.

What is claimed is:

1. A printer comprising a circuit for video-encoding digital images.

2. The printer of claim 1, further comprising a memory reader for reading the digital images from removable memory.

3. The printer of claim 1, further comprising an I/O interface for connection to a remote video display device.

4. The printer of claim 1, further comprising a control panel for selecting the digital images to be printed.

5. The printer of claim 1, wherein the digital images are encoded according to a format for digital television.

6. The printer of claim 1, further comprising a remote control for commanding the circuit to sequence through and select the digital images to be printed.

7. The printer of claim 1, further comprising a controller for controlling the circuit to automatically output the digital images as a slide show.

8. An audio video network comprising:
a digital television; and
a printer including an circuit, connected to the television, for video-encoding a digital image and sending the resulting video stream to the digital television.

9. The network of claim 8, further comprising a remote control, connected to the network, for commanding the printer to display a plurality of digital images and for selecting the digital images to be printed.

10. A printer comprising:
a print engine;
an I/O interface;
a memory card reader; and
a circuit for performing digital video-encoding of an output of the memory card reader and sending the encoded output to the I/O interface.

11. The printer of claim 10, further comprising a control panel for selecting digital images to be printed.

12. The printer of claim 10, wherein the video-encoding is performed according to digital television format.

13. The printer of claim 10, further comprising a remote control for commanding the circuit to display the digital images and select the digital images to be printed.

14. The printer of claim 10, further comprising a controller for controlling the circuit to automatically output the digital images as a slide show.

15. A printer comprising:
means for receiving digital images;
means for video-encoding the digital images; and
means for sending encoded images to a remote video display device.

16. A method of proofing digital images, the method comprising:
supplying digital images to a printer;
video-encoding the digital images within the printer;
sending the encoded images to a remote video display device; and
proofing the images displayed on the video display device.
